(19) United States
(12) Patent Application Publication
(10) Pub. No.: US 2014/0129581 A1
(43) Pub. Date: May 8, 2014

(54) User Intention Data Searching

(71) Applicant: Curtis Ray Droege, Richmond, KY (US)

(72) Inventor: Curtis Ray Droege, Richmond, KY (US)

(21) Appl. No.: 13/668,285

(22) Filed: Nov. 4, 2012

(51) Int. Cl. G06F 17/30

(52) U.S. Cl. CPC G06F 17/30395
USPC 707/759

(57) ABSTRACT

A search method for improving a user's search intention is disclosed. The search method includes a user interface for receiving a search request, input terms connected by input operators, and means for a user to visually associate input terms with an order of query operations.

### BACKGROUND

1. Field of the Disclosure

The present disclosure is directed to an improved method of satisfying a user's data search intentions in a computerized data interface.

2. Background of the Disclosure

Search engines provide a powerful tool for locating documents in a large database of documents, such as the documents on the World Wide Web (WWW) or the documents stored on the computers of an Intranet. The documents are located in response to a search query submitted by a user. A search query may consist of one or more search terms.

In one approach to entering queries, the user enters the query by adding successive search terms connected by logical operators. Once the user signals that all of the search terms of the query are entered, the query is sent to the search engine. The user interface may have alternative ways of entering queries and connecting operators by, for example, entering a query term, a query field, an operator, and so on until complete. The search is initiated by pressing the enter key on a keyboard or by clicking on a “search” button on the screen. Once the query is received, the search engine processes the search query, searches for documents responsive to the search query, and returns a list of documents to the user.

The results of the query will be dependent on the query terms and query fields, but also the order in which the operation is performed. Complex queries, usually having three or more search terms, require careful construction and testing to ensure the intention of the user. It would be desirable to have a system and method of visually assisting the user in defining the order of query operations.

### SUMMARY

A search interface system and method is disclosed to visually assist the user in constructing a complex search query, enabling a user's intention to be achieved with little effort.

The invention includes multiple user inputs connected by operators, user commands to indicate a user's intention for nesting search terms, a visual representation of nested terms, and search algebra modified in response to user commands.

Features and advantages of the present disclosure will be more understood through the detailed description and in reference to the figures which follow.

### BRIEF DESCRIPTION OF THE DRAWINGS

FIG. 1 is a block diagram of an exemplary computer-based search system.

FIG. 2a shows an exemplary multiple input query interface.

FIG. 2b shows an exemplary algebraic query interface.

FIG. 3a shows an improved multiple input query interface, including indent command buttons for indenting input rows, according to one aspect of the invention.

FIG. 3b shows an algebraic query interface corresponding to the input shown in FIG. 3a.

FIG. 4a-d shows simplified multiple input query interface examples, including indenting select rows, according to another aspect of the invention.

FIG. 5a-b shows a flow chart for a method of searching a database of documents, and in particular for created a nested search based on user interface commands, according to another aspect of the invention.

FIG. 5c shows a subroutine for determining parent-child relationships among search input rows.

### DETAILED DESCRIPTION

It is to be understood that various omissions and substitutions of equivalents are contemplated as circumstances may suggest or render expedient, but these are intended to cover the application or implementation without departing from the spirit or scope of the claims of the bladed tool described herein. The present disclosure is capable of other embodiments and of being used in various applications. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

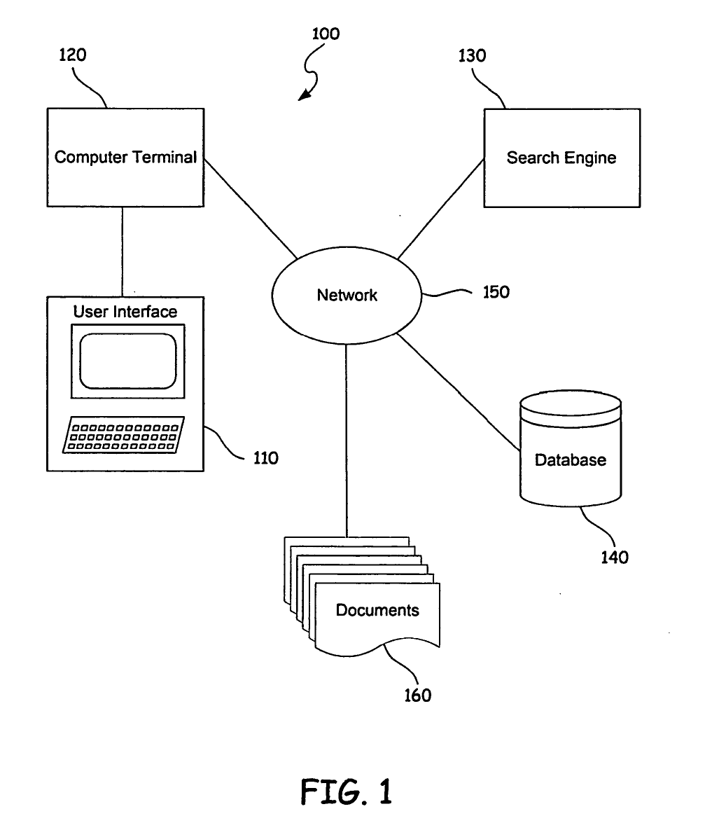

FIG. 1 shows an exemplary search system 100 that includes a computer user interface 110 connected to a computer terminal 120, a search engine 130, a database 140, and network 150. When a search is performed, data 160 results. The computer user interface 110 and computer terminal 120 may be can be any device for processing data. For example, computer user interface 110 and computer terminal 120 can be a personal computer, a tablet computer, a cellular telephone, a computer assisted television, and the like. For the purposes of the following description, it will be assumed that computer interface 110 and computer terminal 120 are personal computers. As shown, computer user interface 110 and computer terminal 120 are connected to a search engine 130. The search engine 130 can reside with the personal computer, or can be located remotely and connected via a network 150. The search engine 130 is designed to search documents based on user input from the computer user interface 110. The user interface 110 can include a graphical user interface, keyboard, mouse, mouse pad, touch screen, voice recognition system, tablet, and the like, or any combination of these. The database 140 can be any device or configuration of devices that stores data 160. Data 160 can include any combination of news articles, periodicals, books, patents and other legal documents, and other similar documents. Further, the database 140 can be any form of electronic data storage, for example, magnetic, optical, solid state, RAM, ROM, and the like. The network 150 may be a single network or a plurality of networks of the same or different types. For example, the network 150 may include a telephone network or a data network. The network 150 may be local, wide-area, regional, national, or global. The network 150 may include any combination of connection schemes between devices.

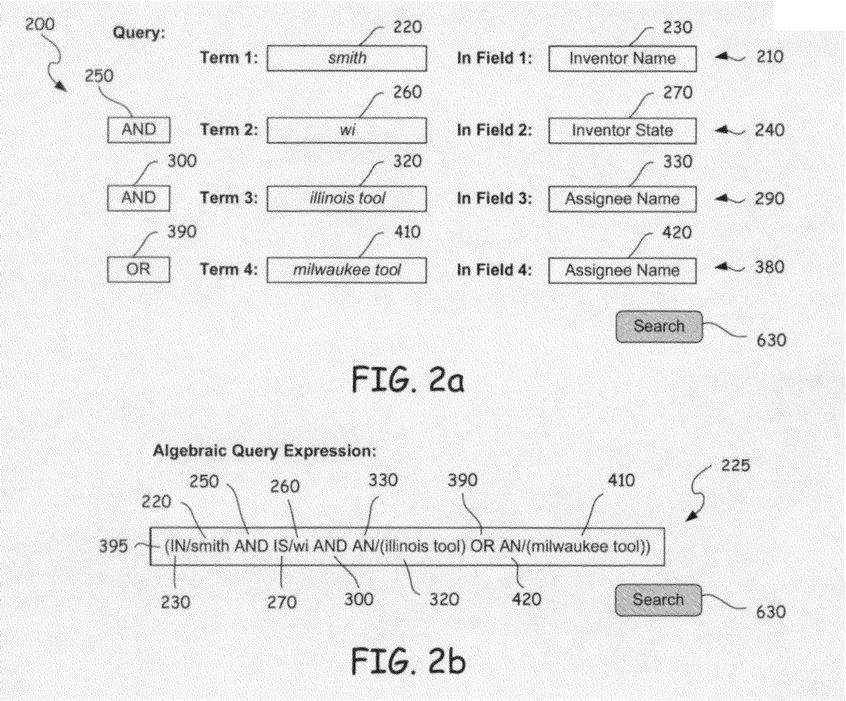

FIG. 2a shows an exemplary search interface 200 capable of multiple user inputs. In this example, search inputs are constructed in search input rows such as user input one 210, user input two 240, user input three 290, and user input four 380, connected by operator one 250, operator two 300 and operator three 390. Operators determine the algebraic connection between search inputs, in which the most common are “AND”, “OR”, “ANDNOT”, and “ORNOT”. Within each row there is at least a query term, which is a text or numeric value to be searched. In addition, this example includes a query field for each row. A query field limits the search to within a specific set of data tagged to include the field name in the database 140. By way of example, query term one 220 includes “smith” entered by a user, and query field one 230 includes “Inventor Name” which may be entered by a user or selected from a pre-defined list. Thus, user input one 210 will result in a search for “smith” within a set of data tagged with “Inventor Name”. User input two 240 includes query term two 260, entered by the user as “wi” (abbreviation for the state of Wisconsin), and query field two 270, entered or selected by the user as “Inventor State”, in addition to operator one 250, entered or selected by the user as “AND”, connecting user input one 210 to user input two 240. Continuing the previous example then, a search for “smith” in “Inventor Name”, “AND” “wi” in “Inventor State” will result. User input three 290 and user input four 380 include identical elements as user input two 240. Query term three 320 includes “Illinois tool”, while query field 330 includes “Assignee Name”. These inputs are joined to the previous terms by operator two 300, in which “AND” is selected. And finally, user input four 380 includes query term four 410 having text entered as “Milwaukee tool” and query field four 420 includes “Assignee Name”. These are joined to the previous rows by operator three 390, in which “OR” is selected. To further illustrate the example in FIG. 2a, alpha characters “A”-“D” will represent user input one through user input four (210, 240, 290, and 380). Operator one through operator three (250, 300, and 390) will be inserted unchanged, resulting in the simplified search expression (“A” AND “B” AND “C” OR “D”). The order of search operation will be to perform each step in sequence, starting with “A” and ending with “D”, thus limiting the ability for a user to express their search intention. The search is executed by a user activating search command 630. A search is performed within one or more databases 140, resulting in documents 160 satisfying the query, which are then returned to the user.

FIG. 2b shows an algebraic method for entering a search, reflecting the search shown in FIG. 2a. Described here as an algebraic search interface 225, this method enables the user to increase the search complexity by grouping, or “nesting”, search elements. This enables user's search intentions to be more closely satisfied by changing the order of search operation. However, for continuity of discussion, the search will be described using identical terms and sequence of operations as described in FIG. 2a. Commonly, query fields are expressed in some abbreviated form. In this example, “Inventor Name” is abbreviated as “IN”, “Inventor State” is abbreviated as “IS”, and “Assignee Name” is abbreviated as “AN”. Further, the “/” symbol is used to associate the query field with the query term. For example, “IN/smith” can be described as “search for all ‘smith’ contained within a data set tagged with ‘inventor name’”. Thus, the advanced query example shown in FIG. 2b is identical in function to the example described in FIG. 2a, resulting in the simplified search expression (“A” AND “B” AND “C” OR “D”).

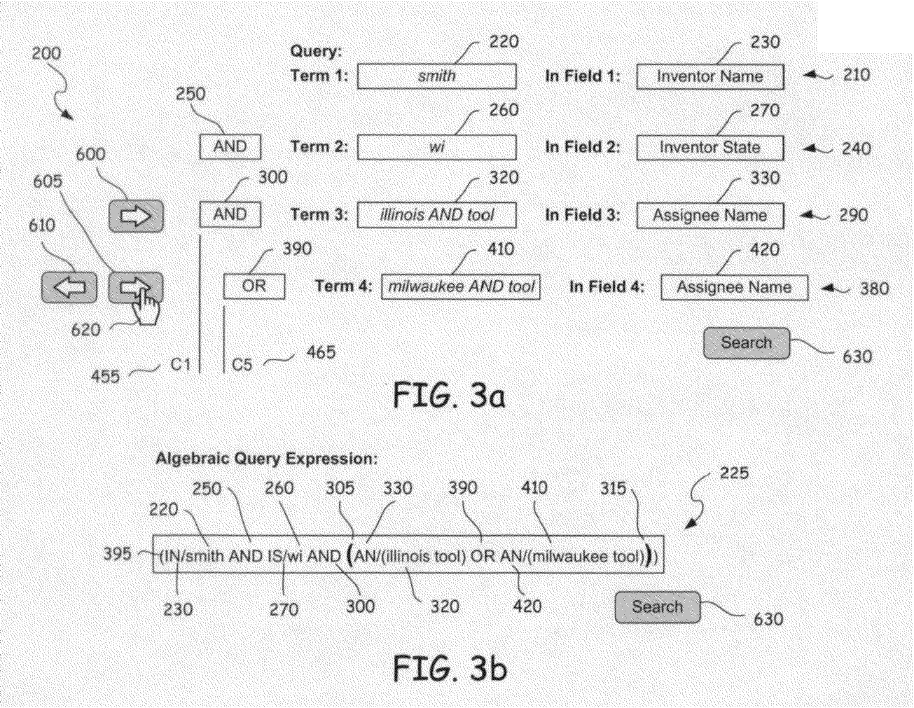

FIG. 3a shows an improved search interface 200 according to one aspect of the invention. Although similar to FIG. 2a, there are essential differences which will now be described. FIG. 3a includes indent command buttons 600 and 605, an outdent command button 610, and a selector icon 620. Preferably, indent command buttons 600 and 605, and outdent command button 610, will be associated with each user input row such as user input three 290 and user input four 380 where these commands can be logically be applied. Logical application of these commands will be discussed later in the text. A selector icon 620, normally used in a computer user interface 110, is used to track the movement of a mouse and activate a command button such as an indent command button 600 or 605, or outdent command button 610 in a common computer graphical user interface. Some user interfaces, such as touchscreens, may provide for direct touch activation of a command button. For clarity and continuity, however, examples shown herein will be described using a selector icon such as selector icon 620. The selector icon 620 is commonly activated by a human interaction such as a mouse click, a touch of a touchscreen, or a tap of a mouse pad. In this example, activation of indent command button 605 by selector icon 620 causes user input four 380 to index to the right, or “indent”, some number of spaces, or column positions. In this example, the first three user input rows, user input one 210, user input two 240, and user input three 290 are shown to start at a column position one, C1 455. In user input four 380, the column is caused to indent to column position five, C5 465. This change in column position provides a visual indication to a user of a change in relationship of user input four 380 relative to user inputs one, two and three (210, 240, and 290, respectively). The change in column position can be any practical number. Once indent command button 605 has been activated, causing user input four 380 to indent, an outdent command button, such as outdent command button 610, appears to conveniently enable a user to change the column position back to the prior position as needed. Although an outdent command button can be always visible, making it visible only when applicable provides an improved user experience. Note that indent command button 600, associate with user input three 290, has not been selected by the user, therefore an outdent command button is not visible, and user input three 290 is not indented, but aligned with C1 455.

FIG. 3b shows the algebraic query expression for the query shown in FIG. 3a. In keeping with the simplified expression described in FIG. 2b, FIG. 3b can be expressed as (“A” AND “B” AND (“C” OR “D”)), wherein the addition of parenthesis (bold and enlarged), described as open nest parentheses 305 and close nest parentheses 315, enables nesting of the terms “C” and “D”. This results in the AND operator 300 being applied to each term within these parenthesis. Thus, the activation of indent command button 605 causes both a visual change to search interface 200 and a change to the algebraic query expression.

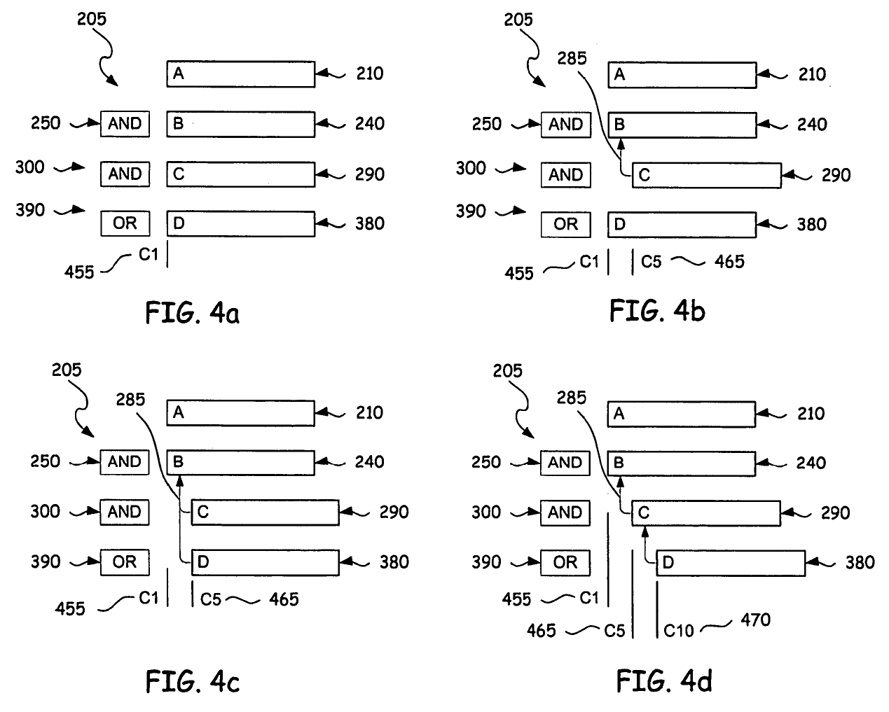

FIG. 4a-d shows search interface 200 in simplified form, described here as simplified search interface 205. Each block represents a user input row. In particular, user input one 210 (including alpha character “A”), user input two 240 (including alpha character “B”), user input three 290 (including alpha character “C”), and user input four 380 (including alpha character “D”). The column position is shown for each block, having a left edge aligned to C1 455, indicating column position one. A user activation of an indent command button, such as indent command button 605 (not shown in this view), will cause a user input row, such as user input three 290 in FIG. 4d, to indent to column position five, C5 465. A second activation of an indent command button will cause a user input row to indent to column position ten, C10 470, and so on.

By way of example, FIG. 4a shows all user input rows aligned to C1 455, having an algebraic equation (A AND B AND C OR D). FIG. 4b shows user input one 210, user input two 240, and user input four 380 aligned with C1 455, but user input three 290 is aligned with C5 465. An arrow, such as indent arrow 285, indicates a “child” relationship to the row above, user input two 240. Conversely, user input two 240 has a “parent” relationship to user input three 290. These “parent-child” relationships provide a user with an easy visual reference for the association of one input row to another. The algebraic equation for FIG. 4b is (A AND (B AND C) OR D). FIG. 4c shows user input three 290 and user input four 380 to each be indented once, resulting in a child relationship to user input two 240, as indicated by indent arrow 285, resulting in the algebraic equation (A AND (B AND C OR D)). FIG. 4d shows user input three 290 to be indented once, and user input four 380 to be indented twice. Thus, user input three 290 has a child relationship to user input two 240, and user input four 380 has a child relationship to user input three 290, as indicated by indent arrows 285. The algebraic equation for FIG. 4d is (A AND (B AND (C OR D))). These indent arrows have been shown to clarify the relationships of input rows, but may optionally be shown in a user interface such as search interface 200.

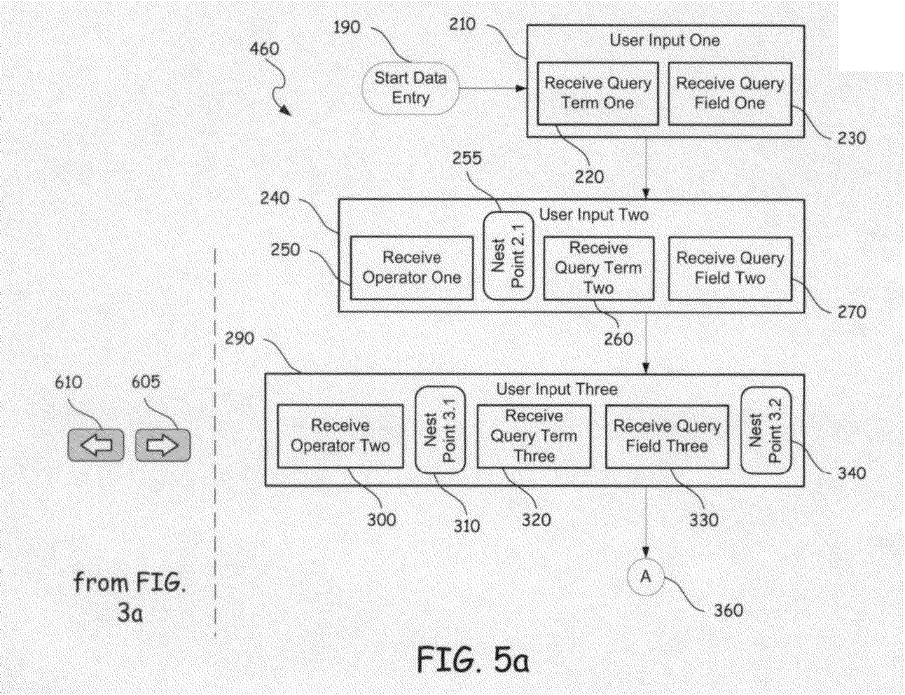

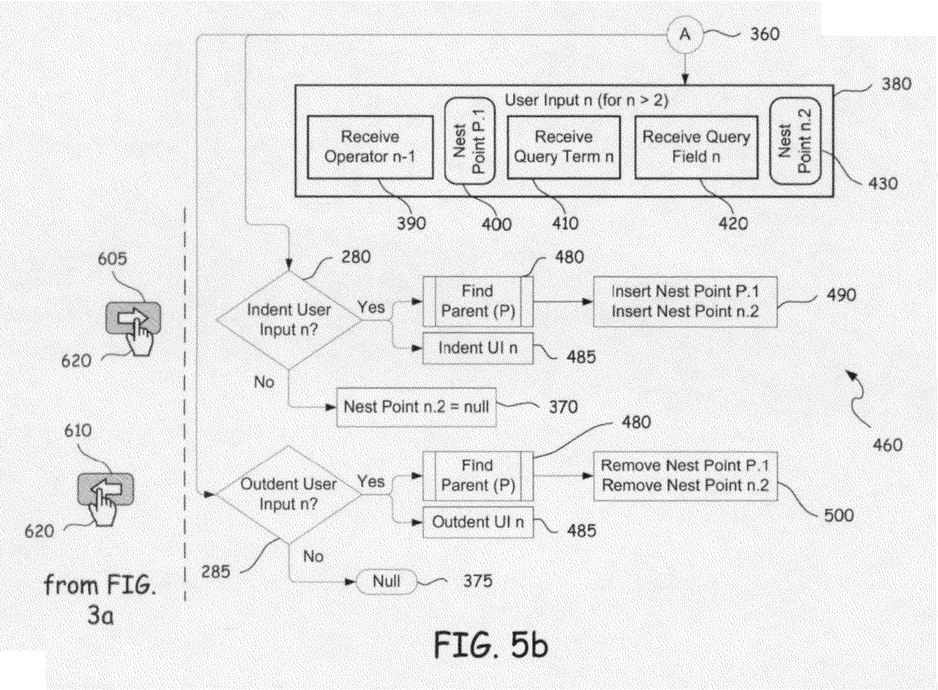

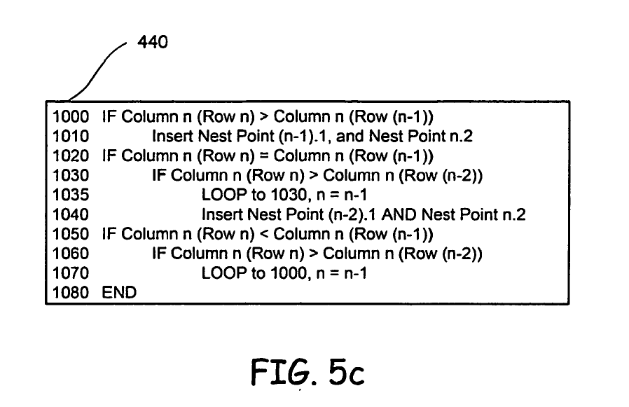

FIG. 5a shows a flow chart for a method of searching a database of documents, and in particular for creating a nested search based on user interface commands, according to one aspect of the invention. The nested search flowchart 460 includes multiple user inputs. User input one 210 includes query term one 220, and may optionally include query field one 230. User input two 240 includes operator one 250, query term two 260, and optionally includes query field two 270. In addition, user input two 240 includes nest point 2.1 255. As shown in FIG. 4a-d, nest points are logical points in an algebraic search capable of grouping, or “nesting” one or more terms. In an algebraic search, logical nesting may be accomplished by inserting open parentheses at a first nest point after a first operator in a first user input row, and close parentheses at another nest point after in a second user input row, thereby affecting the order of search operation. In the flow charts, first nest points are designated with a “0.1” suffix, and second nest points are designated with a “0.2” suffix. Since a first operator, such as operator one 250, occurs after a first user input row, such as query field one 230, a first nest point does not occur in the first user input row, such as user input one 210. Further, nesting should not logically occur in a same user input row, therefore a second nest point in query field two does not occur until the third input row, user input three 290. User input three 290 includes operator two 300, nest point 3.1 310, query field three 320, optionally query term three 330, and nest point 3.2 340. Nesting is controlled by indent command buttons such as indent command button 600 or 605, or outdent command button 610, as discussed in the description of FIG. 3a above. The essential features of FIG. 3a are shown for clarity, and separated from the figure by a vertical dashed line. FIG. 5a ends with page reference A 460, to be continued in FIG. 5b.

FIG. 5b continues from page reference A 460. In parallel, nest decision three 280 receives the user's decision to nest user input three 290. If no, there is no change, resulting in a null response 370. If yes, a visual/algebraic command 350 results for that user input. The visual change may include indenting or outdenting a user input row, wherein a first column position could be changed to another, such as from C1 455 to C5 465, as shown in FIG. 4a. Alternately other visual changes may occur as described previously. The visual changes indicate parent-child relationships among user input rows. User input n 380 includes a first nest point and a second nest point, therefore applies to user inputs greater than 2 (user input n>2). Query term n 410 is entered or selected by the user, and may optionally include query field n 420. Operator (n−1) 390 is also entered or selected. The order of entry is not important. Nest points P.1 and n.2 are shown in their predefined positions. In parallel, the user may indent rows by selecting indent command button 605, for example, by clicking selector icon 620 for example, to visibly and algebraically modify the search. The essential features of FIG. 3a are shown for clarity, and separated from the figure by a vertical dashed line. Selecting an indent command button results in a “yes” response to the indent user input n 280 decision box. The execution of subroutine find parent 480 results, in addition to indenting the user input row, as shown by indent UI row 485. Subroutine find parent 480 will determine proper placement of parenthesis, within their predefined positions, to nest input rows based on the user's intent, causing insertion of nest points, as shown in insert nest points 490. The subroutine will be discussed further in an upcoming section. If an indent command button is not selected, nest point n.2 receives a null value, as shown in null nest point n.2 370. If an outdent command button is selected by the user, by clicking selector icon 620 for example, on as outdent command button such as outdent command button 610, a visibly and algebraically modified search will also result. The execution of subroutine find parent 480 will determine proper placement of parenthesis as described above, in addition to outdenting the user input row, as shown by outdent UI n 485. Nest points will be removed according to remove nest points 500.

FIG. 5c discloses the details of the subroutine find parent 480. Generally the subroutine identifies a row having a difference in column position from the row above. If so, the appropriate nest points are inserted. If, say, user input three 390 and user input four 380 have each been indented once relative to user input two 240, then both will be the child of input user input two 240. Now, the subroutine will be described, referring to the pseudo code referenced as command line 440: Command line 1000 seeks a current row having a column number greater than the preceding row. If true, command line 1010 inserts a parentheses in the preceding row, such as nest point 2.1 255, and another parentheses in the current row such as nest point 3.2 340, both shown in FIG. 5a. Command line 1020 seeks a current row having an identical column number than the preceding row. If so, the next preceding row, then another, is sought until a parent is found, as shown in command lines 1030 and 1035. Then a first parentheses is inserted at the proper row position in the parent row, and a second parentheses is inserted at the proper row position in the child row, as shown in command line 1040. According to command line 1050, if the column position of the current row is less than the preceding row, then loop to command line 1000 to re-run the other conditions. Once all conditions are satisfied, subroutine find parent 480 ends according to command line 1080. Ideally, subroutine find parent 480 will be executed with each activation of a command button, such as indent command button 605 or outdent command button 610.

Although only four input rows are shown, additional rows can be reasonably added. And although input rows are indented only twice, the number of indents is coupled to the number of rows, and the need for additional nesting complexity. Therefore, the number of indents may be greater than two. The number of outdents should match the number of indents.

It is contemplated, and will be clear to those skilled in the art that modifications and/or changes may be made to the embodiments of the disclosure. Accordingly, the foregoing description and the accompanying drawings are intended to be illustrative of the example embodiments only and not limiting thereto, in which the true spirit and scope of the present disclosure is determined by reference to the appended claims.

What is claimed is:

1. A search method comprising:
a user interface for receiving a search request;
at least three input terms connected by at least two input operators;
a user input command means capable of visually associating input terms with an order of query operations;
said user input command means also capable of modifying said order of query operations.

2. The search method of claim 1 wherein said input terms are arranged in substantially horizontal rows.

3. The search method of claim 1 wherein said input terms are arranged in substantially vertical columns.

4. The search method of claim 2 further comprising changing a column position responsive to said user input command means.

5. The search method of claim 3 further comprising changing a row position responsive to said user input command means.

6. The search method of claim 1 further comprising a first nest point associated with a first user input row, and a second nest point associated with a second user input row.

7. The search method of claim 6 wherein said nest points define insertion points for parenthesis in affecting said order of query operations.

8. The search method of claim 6 wherein said nest points define insertion points for parenthesis in affecting said order of query operations responsive to a change in a user interface.

9. A computer-implemented method for visually associating input terms with an order of operation, the method comprising:
receiving text search input terms;
receiving input operators;
receiving indent commands;
receiving outdent commands;
visually changing user interface responsive to indent or outdent commands;
changing the order of query operations responsive to indent or outdent commands;
search database responsive to search command;
return documents satisfying query to user.

10. A computer-implemented method for visually associating input terms with an order of operation, the method comprising:
receiving text search input terms;
receiving input operators;
receiving indent commands;
receiving outdent commands;
visually changing user interface responsive to indent or outdent commands;
changing the order of query operations responsive to visual changes of user interface;
search database responsive to search command;
return documents satisfying query to user.
